(19) United States
(12) Patent Application Publication
(10) Pub. No.: US 2006/0095426 A1
(43) Pub. Date: May 4, 2006

(54) System and method for creating document abstract

(76) Inventors: Katsuhiko Takachio, Kokubunji-shi (JP); Koichi Sasaki, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/230,464

(22) Filed: Sep. 21, 2005

(30) Foreign Application Priority Data
Sep. 29, 2004 (JP) 2004-284674

(51) Int. Cl. G06F 17/30

(52) U.S. Cl. 707/4

(57) ABSTRACT

The present invention provides a system and method for creating a document abstract, the system and method retrieving a document on the basis of input retrieval conditions and extracting a range suitable for an abstract from the retrieved document on the basis of input abstract creation conditions. The document abstract creating system includes a candidate range setting portion which sets candidate ranges one of which is extracted as an abstract, in the retrieved document on the basis of input range setting conditions. To extract a part suitable for the abstract, one of the candidate ranges set by the candidate range setting portion is extracted.

### CROSS-REFERENCE TO RELATED APPLICATIONS

This application is based upon and claims the benefit of priority from prior Japanese Patent Application No. 2004-284674, filed Sep. 29, 2004, the entire contents of which are incorporated herein by reference.

### BACKGROUND OF THE INVENTION

1. Field of the Invention

The present invention is applied to a technique for creating an abstract by extracting a range suitable for the abstract from a document on the basis of the contents of a question to create an abstract. In particular, the present invention relates to a system and method for creating a document abstract, which system and method can adjust candidate ranges that are candidates one of which is extracted as an abstract.

2. Description of the Related Art

In a conventional document abstract creating system that creates an abstract by extracting a range suitable for the abstract from a document on the basis of the contents of a question formed using a natural language, the abstract is specifically created following the procedure shown below as disclosed in, for example, Jpn. Pat. Appln. KOKAI Publication No. 2003-256425.

First, a question formed using the natural language is subjected to morphemic analysis and divided into words. Each of the words obtained is subjected to semantic analysis by comparing it with dictionary data. The meanings (time, person, location, and the like) of particular words are determined.

Then, morphemic and semantic analyses are similarly executed on a plurality of documents that can be targets for an abstract. Abstract target ranges, that is, ranges each of which can be a candidate for the abstract (referred to as “candidate ranges” below), are extracted in accordance with a fixed selecting method using a document unit such as a “new line unit” or a “period unit”. Then, for each of the extracted candidate ranges, the results of the morphemic and semantic analyses are compared with those of the morphemic and semantic analyses executed on the question. A candidate shown by the results of the collation to have a high level of coincidence is determined to be an abstract for the question. However, such a conventional document abstract creating method presents the problems described below.

This method uses the fixed method for selecting candidate ranges. That is, with such a fixed selecting method as “considers a new line unit as a document”, if a new line is created for every semantic unit as in the case of an itemized part, the entire itemized part cannot be selected as a candidate range.

For example, the case will be considered in which an abstract for the question “What is the conventional abstract method?” is extracted from a target document such as the one shown below.

(Target Document)

“With the conventional abstract technique, <new line 1>

1. A question formed using the natural language is subjected to morphemic analysis and divided into words. Further, on the basis of the semantic analysis, the meanings (time, person, location, and the like) of particular words are determined. <new line 2>

2. A group of abstract target documents is also subjected to morphemic and semantic analyses. Target ranges are considered to correspond to fixed selecting means, that is, document units such as “new line units” or “period units”. The results of morphemic and semantic analyses executed on each target range are collated with the results of morphemic and semantic analyses executed on the question. The closest target range is determined to an abstract of the document.

<new line 3>

This is how the conventional abstract technique is executed.”<new line 4>

The above target document has four new lines. However, each of the ranges separated from one another by the new lines is considered to be one candidate range. Consequently, for the question “What is the conventional abstract method”, the entire target document cannot be presented as an abstract, though it is appropriate as the abstract.

### BRIEF SUMMARY OF THE INVENTION

The present invention has been made in view of these circumstances. It is an object of the present invention to provide a system and method for creating a document abstract, which enable arbitrary setting of candidate ranges one of which is extracted as an abstract for a question.

The present invention uses the means described below in order to accomplish the above object.

The present invention provides a system and method for creating a document abstract, the system and method retrieving a document on the basis of input retrieval conditions and extracting a range suitable for an abstract from the retrieved document on the basis of input abstract creation conditions, wherein candidate ranges one of which is extracted as an abstract are set in the retrieved document on the basis of input range setting conditions. To extract a part suitable for the abstract, one of the set candidate ranges is extracted. The range setting conditions include, for example, at least one of a limit condition that limits the retrieved document and a format condition for the candidate ranges. Such range setting conditions may be input by an interactive input accepting means. The present invention relating to the above system and method is established as a program for allowing a computer to execute the above process.

The present invention using the above means enables a part appropriate as an abstract to be extracted even from documents in various expression styles. Further, setting range setting conditions makes it possible to limit the document to be retrieved and to carefully specify candidate ranges. Thus, a more precise abstract can be created.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a functional block diagram showing an example of a document abstract creating system to which a method for creating a document abstract according to an embodiment of the present invention is applied;

FIG. 2 is a conceptual drawing showing an example of an interactive input screen used to input abstract creation conditions, retrieval conditions, and range setting conditions;

FIG. 3 is a block diagram showing an example of the functional configuration of a retrieval engine in detail;

FIG. 4 is a flowchart showing operations of the document abstract creating system to which the method for creating a document abstract according to the embodiment of the present invention is applied;

FIG. 5 is a diagram showing an example of a document retrieved by a document retrieving section;

FIG. 6 is a diagram showing an example of the document for which candidate ranges have been set;

FIG. 7 is a diagram showing another example of the document for which candidate ranges have been set; and

FIG. 8 is a diagram showing an example of an abstract extracted by an abstract extracting section.

### DETAILED DESCRIPTION OF THE INVENTION

With reference to the drawings, description will be given of the best mode for carrying out the present invention.

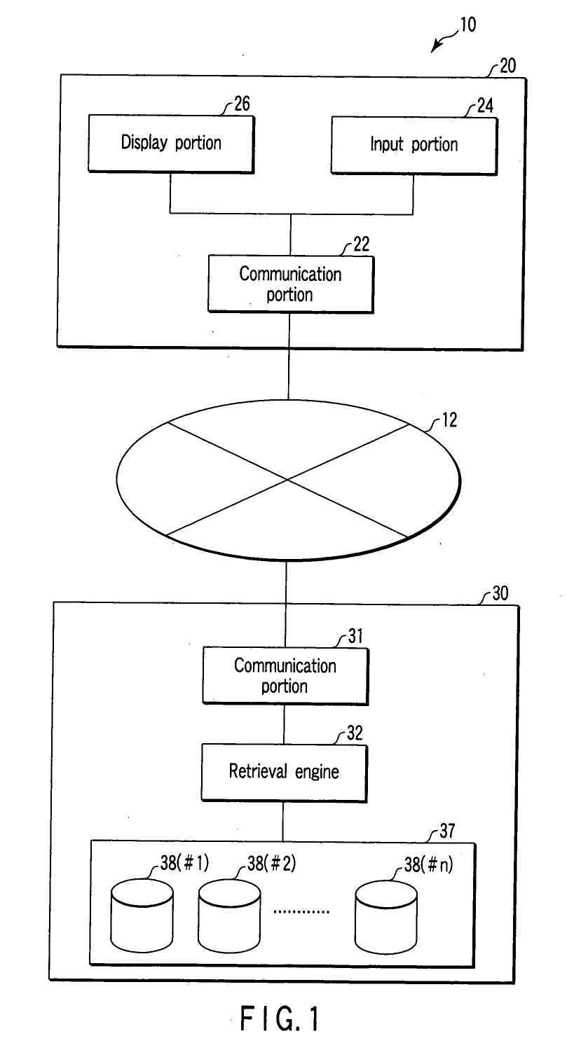

FIG. 1 is a functional block diagram showing an example of a document abstract creating system to which a method for creating a document abstract according to an embodiment of the present invention is applied.

A document abstract creating system 10 according to an embodiment of the present invention is composed of a client 20 and a server 30 connected together via a communication network 12 such as the Internet. The server 30 retrieves a document on the basis of retrieval conditions input by the client 20. Further, the server 30 creates an abstract of the document by extracting a candidate range suitable for the abstract on the basis of abstract creation conditions input by the client 20, the candidate range being included in those which are set in the retrieved document on the basis of range setting conditions input by the client 20.

The client 20 comprises a communication portion 22 that transmits and receives data to and from the server 30 via a communication network 12, an input portion 24 including input tools such as a keyboard and a mouse (not shown) so that a user can use the input tools to input data such as the retrieval conditions, the abstract creation conditions, and the range setting conditions, and a display portion 26 consisting of, for example, a display to display data received by the communication portion 22 from the server 30 and the data such as the retrieval conditions, abstract creation conditions, and range setting conditions which are input from the input portion 24. To input the data such as the retrieval conditions, abstract creation conditions, and range setting conditions from the input portion 24, the user can display an interactive input screen on the display portion 26 and input the data in accordance with the interactive input screen displayed on the display portion 26.

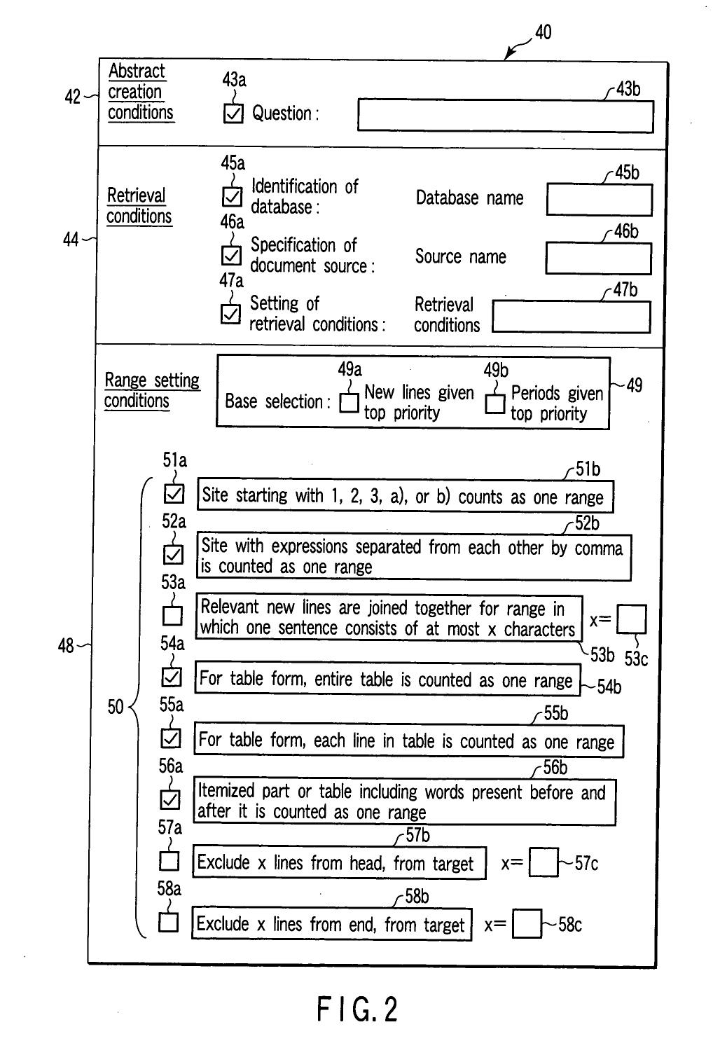

FIG. 2 is a conceptual drawing showing an example of an interactive input screen 40 displayed on the display portion 26 so that the user can input the abstract creation conditions, retrieval conditions, and range setting conditions altogether from the input portion 24.

The input screen 40 consists of an abstract creation condition input section 42, a retrieval condition input section 44, and a range setting condition input section 48.

The abstract creation condition input section 42 includes an application check section 43a and a question input section 43b. To set the abstract creation conditions, the user checks the application check section 43a (a check mark is shown in FIG. 2) and inputs a question formed using the natural language and used to create an abstract, to the question input section 43b.

The retrieval condition input section 44 comprises an application check section 45a that is checked to specify the name of a database to be searched, a database name input section 45b to which the name of one of a plurality of databases 38 (#1, #2, . . . , #n) included in a database portion 37 which is to be specified and searched is input, an application check section 46a that is checked to specify the source (for example, the URL) of a document to be retrieved, a source name input section 46b to which the source name is input if the application check section 46a has been checked, an application check section 47a that is checked to specify retrieval conditions such as a keyword, an update date, and a file format, and a retrieval condition input section 47b to which the retrieval conditions are input if the application check section 47a has been checked.

The range setting condition input section 48 is a section to which the range setting conditions are input, the range setting conditions setting candidate ranges in the document one of which is extracted as an abstract. The range setting condition input section 48 comprises a base selection section 49 and a format setting section 50. To specify candidate ranges with new lines given top priority, the user checks the application check section 49a in the base selection section 49. To specify candidate ranges with periods given top priority, the user checks the application check section 49b in the base selection section 49. For the preferred item specified in the base selection section 49, further detailed format conditions are set in the format setting section 50. For such specific items as shown at 51b, 52b, . . . , 58b in the figure as format conditions, application check sections 51a, 52a, . . . , 58a corresponding to items to be applied are checked. If the application check sections 53a, 57a, and 58a are checked, specific numerical values are specified by inputting the corresponding number of characters to a character number input section 53c, the corresponding number of lines from the head to a head line number input section 57c, and the corresponding number of lines from the end to an end line number input section 58c. The format setting section 50 shown in FIG. 2 is only illustrative. Further detailed range setting conditions may be input by adding other items.

The server 30 comprises a communication portion 31 which retrieves a document on the basis of the retrieval conditions, abstract creation conditions, and range setting conditions input by the input portion 24 utilizing the input screen 40 such as the one shown in FIG. 2 and which creates an abstract of the retrieved document, the communication portion 31 transmitting and receiving data to and from the client 20 via the communication network 12, the database portion 37 including the one or more databases 38 (#1, #2, . . . , #n) storing document data, and a retrieval engine 32 which searches the databases 38 (#1, #2, . . . , #n) provided in the database portion 37, for a document on the basis of the retrieval conditions, abstract creation conditions, and range setting conditions sent to the communication portion 31 by the client 20 and which creates an abstract of the retrieved document.

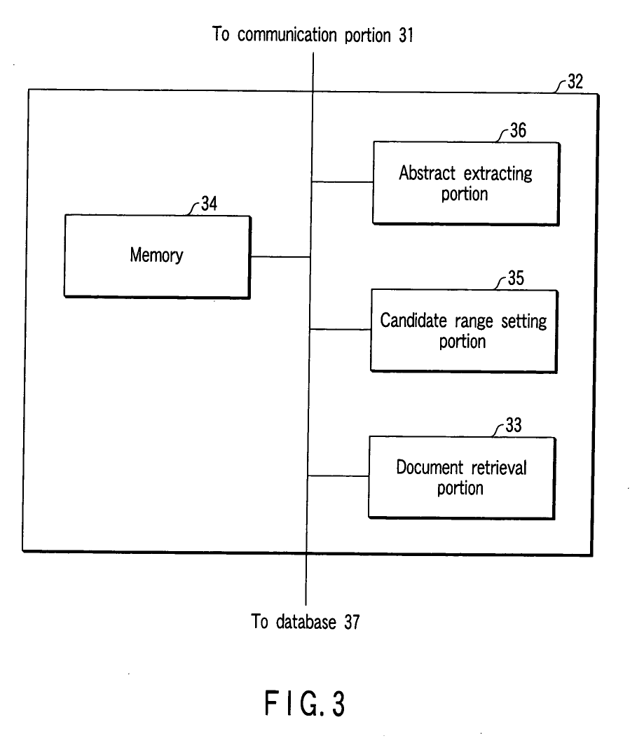

FIG. 3 is a block diagram showing an example of the functional configuration of the retrieval engine 32 in detail. The retrieval engine 32 comprises a document retrieval portion 33, a memory 34, a candidate range setting portion 35, and an abstract extracting portion 36.

When the client 20 sends the retrieval conditions, the abstract creation conditions, and the range setting conditions to the communication portion 31, the document retrieval portion 33 searches the databases 38 (#1, #2, . . . , #n) provided in the database portion 37, for the document based on the retrieval conditions. The document retrieval portion 33 stores the retrieved document in the memory 34.

The candidate range setting portion 35 acquires the document stored in the memory 34. The candidate range setting portion 35 sets candidate ranges one of which is extracted as an abstract, for the document acquired on the basis of the range setting conditions included in the retrieval conditions, abstract creation conditions, and range setting conditions sent to the communication portion 31 by the client 20. The candidate range setting portion 35 then separates the document acquired into the set candidate ranges. The candidate range setting portion 35 overwrites and stores the document separated into the candidate ranges, to and in the memory 34.

On the basis of the abstract creation conditions included in the retrieval conditions, abstract creation conditions, and range setting conditions sent to the communication portion 31 by the client 20, the abstract extracting portion 36 executes morphemic and semantic analyses, which are well-known techniques, on the question consisting of the natural language and input to the question input section 43b. The morphemic and semantic analyses are well-known techniques and will thus not be described in detail.

Moreover, the abstract extracting portion 36 similarly executes morphemic and semantic analyses on each of the candidate ranges in the document stored in the memory 34. The abstract extracting portion 36 collates the results of the morphemic and semantic analyses executed on the question with those of the morphemic and semantic analyses executed on each of the candidate ranges. The abstract extracting portion 36 then extracts, as a part suitable for an abstract, a candidate range shown by the results of the collation to have the highest level of coincidence. The abstract extracting portion 36 then outputs the extracted candidate range to the communication portion 31.

Then, the communication portion 31 transmits data corresponding to the candidate range extracted by the abstract extracting portion 36, to the client 20 via the communication network 12. The data is received by the communication portion 22 of the client 20 and displayed on the display portion 26. The user views the display to obtain the abstract for the specified question.

The present system 10 configured as described above is implemented by a computer which loads a program stored in storage media, for example, a magnetic disk, or a program downloaded via a network such as the Internet and which has its operation controlled by the program.

Examples of the storage media include a magnetic disk, a floppy disk, a hard disk, an optical disk (CD-ROM, DVD, or the like), a magneto-optical disk (MO or the like), and a semiconductor memory. The storage media may have any storage form provided that it can store programs and is readable by the computer.

Each of the processes for carrying out the embodiment may be partly executed by an operating system (OS) running on a computer on the basis of instructions from a program installed in the computer or middleware (MW) such as database management software or network software.

Moreover, examples of the storage media are not limited to those independent of a computer but include those which download and store or temporarily store a program transmitted through a LAN, the Internet, or the like.

The number of storage media according to the embodiment is not limited to one but the processes according to the embodiment may be executed from a plurality of media. The media may be arbitrarily configured.

The computer according to the embodiment executes the processes according to the embodiment on the basis of the program stored in the storage media. The computer may be, for example, a unitary apparatus such as a personal computer or a system composed of a plurality of apparatuses connected together through a network. Examples of the computer are not limited to the personal computer but include, for example, an arithmetic processing apparatus or microcomputer included in information processing equipment. The computer is a generic name for equipment and apparatuses that can realize the functions of the present invention on the basis of the program.

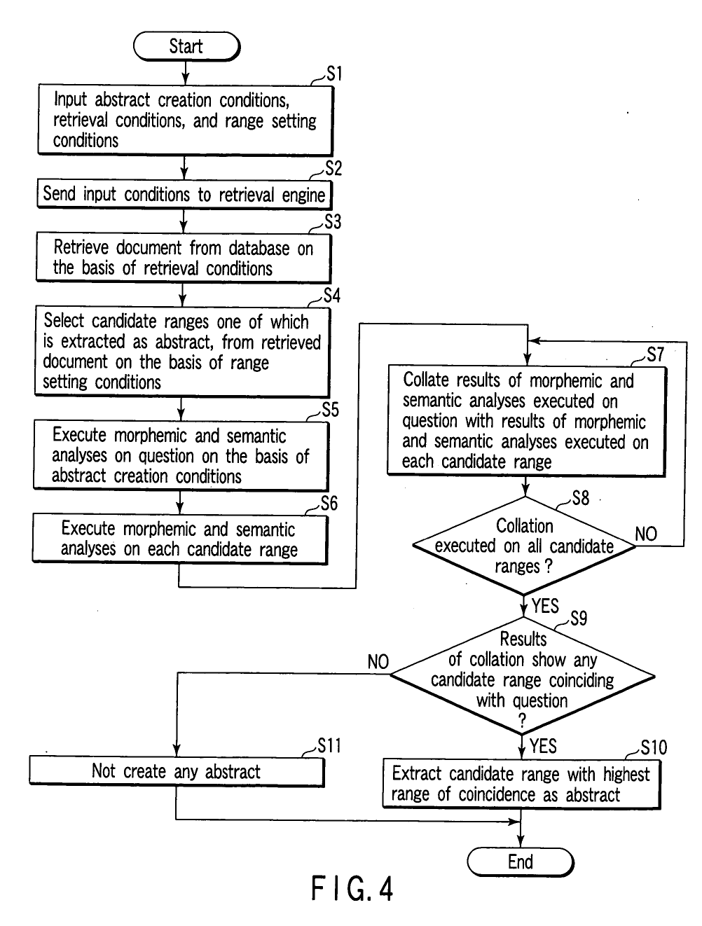

Now, with reference to the flowchart shown in FIG. 4, description will be given of operations of the document abstract creating system 10 to which the method for creating a document abstract according to the embodiment configured as described above is applied.

To create an abstract using the document abstract creating system 10 to which the method for creating a document abstract according to the embodiment is applied, the user first inputs the abstract creation conditions, the retrieval conditions, and the range setting conditions from the input portion 24 (S1) The user specifies the abstract creation conditions by checking the application check section 43a in the abstract creation condition input section 42 and inputting a question (for example, “What is the process like through which information affects productivity?”) consisting of the natural language to the question input section 43b.

Further, the user specifies the retrieval conditions by checking desired ones of the application check sections 45a, 46a, and 47a in the retrieval condition input section 44 and inputting required data to the sections (any of 45b, 46b, and 47b) corresponding to the checked items. For example, the database 38 in which the document to be retrieved is stored is specified by checking the application check section 45a and inputting the name of the database (for example, one of the databases 38 [#1, #2, . . . , #n]) to be searched, to the database name input section 45b. Further, the user specifies the source (creator) of the document to be retrieved by checking the application check section 46a and inputting the name of the source (for example, a URL) to the source name input section 46b. Moreover, the user specifies the retrieval conditions by checking the application check section 47a and inputting, for example, a keyword, an update date, and a file format to the retrieval condition input section 47b.

Moreover, in the range setting condition input section 48, whether new lines or periods are given top priority as a setting condition for a candidate range extracted as an abstract is specified by checking the application check section 49a or 49b in the base selection section 49. If the new lines are given top priority, a candidate range is set for every new line. In this case, if a new line is specified for every item in an itemized part, each item is determined to be a candidate range. On the other hand, if the periods are given top priority, a candidate range is set for every sentence. In this case, even if a new line is specified for every item in the itemized part, the entire itemized part can be determined to be one candidate range because the range from period to period is specified as a candidate range. Then, the user checks desired ones of the application check sections 51a, 52a, . . . , 58a, provided in the format setting section 50. If the application check sections 53a, 57a, and 58a have been checked, the user inputs the corresponding number of characters to the character number input section 53c, the corresponding number of lines from the head to the head line number input section 57c, and the corresponding number of lines from the end to the end line number input section 58c. Thus, the detailed range setting conditions for the candidate range have been specified.

To input these conditions, the user inputs desired data while referencing the interactive input screen 40, which is displayed on the display portion 26 and an example of which is shown in FIG. 2.

The conditions thus input from the input portion 24 are sent from the input portion 24 to the communication portion 22. The conditions are then transmitted from the communication portion 22 to the communication portion 31 of the server 30 via the communication network 12. The conditions are further transmitted from the communication portion 31 to the retrieval engine 32 (S2).

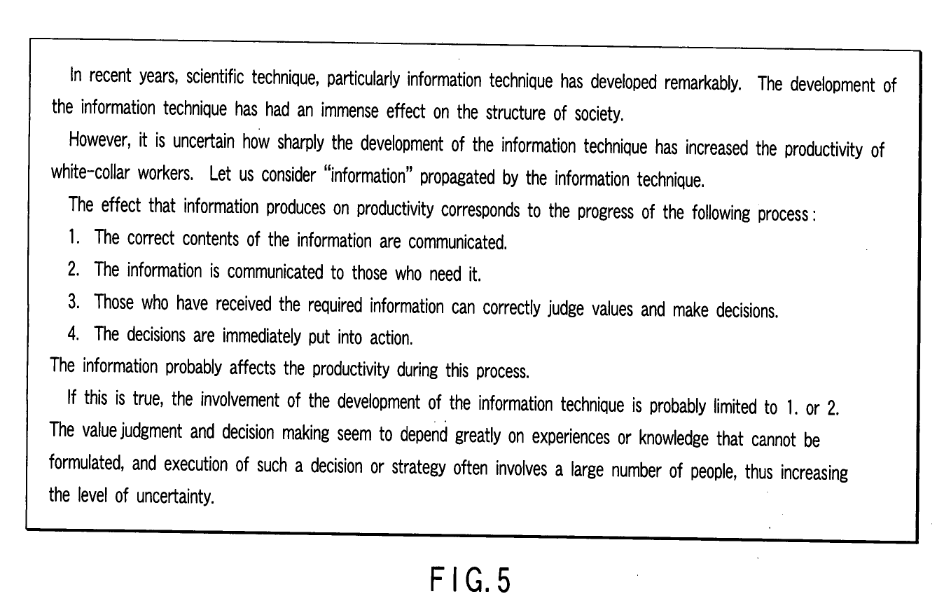

In the retrieval engine 32, the document retrieval portion 33 searches the specified database 38 for the document on the basis of the abstract creation conditions, retrieval conditions, and range setting conditions transmitted by the client 20 (S3). If the retrieval conditions are, for example, “database 38 (#1)” input to the database name input section 45b, “nippon.com” input to the source name input section 46b, and “scientific technique” input to the retrieval condition input section 47b, a document is retrieved which is stored in the database 38 (#1) and which has been created by “nippon.com”, the document containing the keyword “scientific technique”. The retrieved document is stored in the memory 34. FIG. 5 shows an example of a document retrieved in this manner.

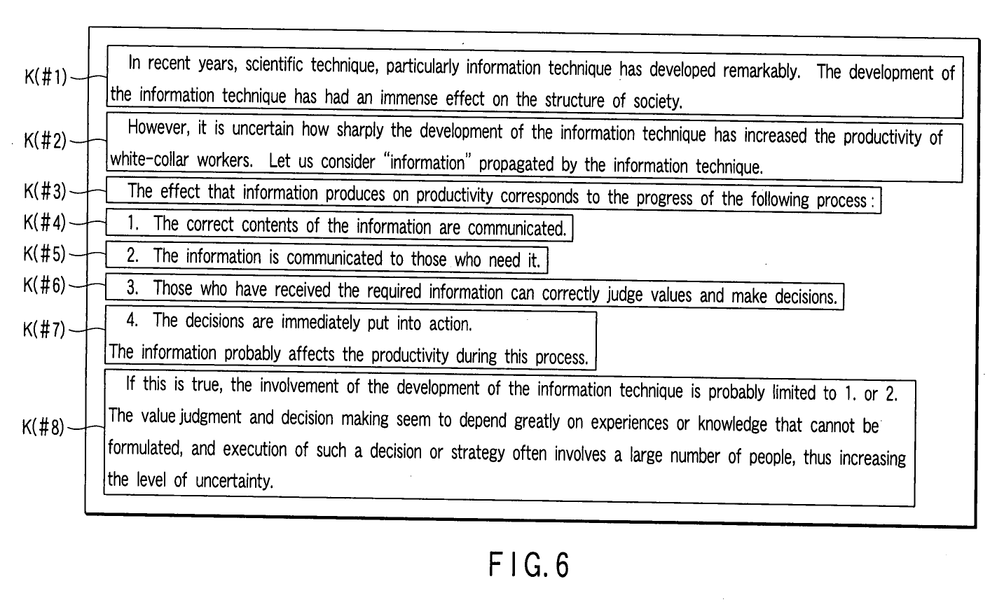

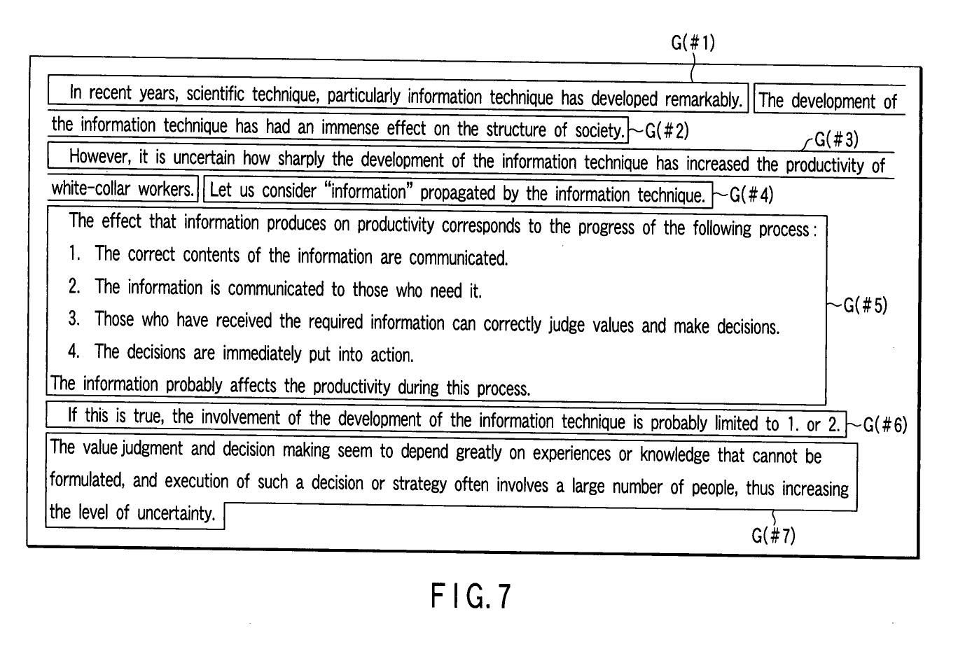

Then, the candidate range setting portion 35 sets candidate ranges one of which is extracted as an abstract, in the document stored in the memory 34 by the document retrieval portion 33, on the basis of the retrieval conditions, abstract creation conditions, and range setting conditions transmitted to the communication portion 31 by the client 20 (S4). For example, if the application check section 49a is checked in the base selection section 49, then in the document stored in the memory 34, the area between every two contiguous new lines is a candidate range K (#1 to #8) as shown in FIG. 6. On the other hand, if the application check section 49b is checked, then in the document stored in the memory 34, each sentence is a candidate range G (#1 to #7) as shown in FIG. 7. Further, the further detailed range setting conditions conform to the contents set in the format setting section 50. The document separated into these candidate ranges is overwritten to and stored in the memory 34.

The abstract extracting section 36 executes morphemic and semantic analyses on the question formed using the natural language and input to the question input section 43b, on the basis of the retrieval conditions, abstract creation conditions, and range setting conditions transmitted to the communication portion 31 by the client 20 (S5). If for example, the question “What is the process like through which information produces an effect on productivity?” is input to the question input section 43b, the morphemic analysis extracts the words “information”, “productivity”, “effect”, “produce”, and “process”. Moreover, each of the extracted words is compared with dictionary data (not shown) provided in the system 10 to determine the meaning of the word. If for example, the words “2004”, “Taro Tokyo”, and “Hachioji are extracted, these words are compared with the dictionary data. Thus, “2004” is identified as a date, “Taro Tokyo” is a person, and “Hachioji” is a location.

Moreover, the abstract extracting portion 36 similarly executes morphemic and semantic analyses on each of the candidate ranges in the document stored in the memory 34 (S6). Then, the results of the morphemic and semantic analyses executed on the question are collated with those of the morphemic and semantic analyses executed on each candidate range (S7).

Such collation is executed on all the candidate ranges (S8). If the results of the collation shows that for the results of the morphemic and semantic analyses, no candidate range coincides with the question (S9: No), the system determines that no candidate range is suitable for an abstract and does not create any abstract (S11). On the other hand, if any candidate ranges coincide with the question (S9: Yes), one of the candidate ranges which has the highest level of coincidence is extracted as an abstract (S10).

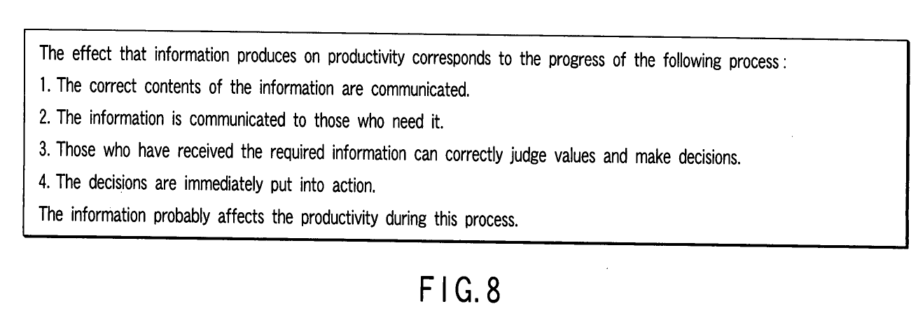

The abstract extracting portion 36 outputs the extracted candidate range to the communication portion 31, which then transmits the candidate range to the client 20 via the communication network 12. The data is received by the communication portion 22 of the client 20 and displayed on the display portion 26. The user views the display to obtain the abstract for the specified question. FIG. 8 shows an example of an abstract thus obtained. FIG. 8 shows one G(#5) of the candidate ranges G(#1) to G(#7) set as shown in FIG. 7. The candidate range G(#5) contains the words “information”, “productivity”, “effect”, and “produce” and thus has the highest level of coincidence with the question “What is the process like through which “information” “produces” an “effect” on “productivity”?”. Therefore, the candidate range G(#5) is extracted as an abstract.

As described above, with the document abstract creating system to which the method for creating a document abstract according to the embodiment is applied, candidate ranges one of which is extracted as an abstract can be arbitrarily set on the basis of the above effects. As a result, a part appropriate as an abstract can be extracted even from documents in various expression styles. Further, setting the range setting conditions makes it possible to limit the document to be retrieved and to carefully specify candidate ranges. Thus, a more precise abstract can be created.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A document abstract creating system which retrieves a document on the basis of input retrieval conditions and which extracts a range suitable for an abstract from the retrieved document on the basis of input abstract creation conditions, the system comprising:
a candidate range setting section configured to set candidate ranges one of which is extracted as the abstract, in the retrieved document on the basis of input range setting conditions,
wherein to extract a part suitable for the abstract, one of the candidate ranges set by the candidate range setting section is extracted.

2. The document abstract creating system according to claim 1, wherein the range setting conditions include at least one of a limit condition which limits the document to be retrieved and a format condition for the candidate ranges.

3. The document abstract creating system according to claim 2, further comprising an interactive input accepting section configured to accept input of the range setting conditions.

4. The document abstract creating system according to claim 1, further comprising an interactive input accepting section configured to accept input of the range setting conditions.

5. A method for creating a document abstract, the method retrieving a document on the basis of retrieval conditions input by an input device and extracting a range suitable for an abstract from the retrieved document on the basis of abstract creation conditions input by the input device, the method comprising:
setting candidate ranges one of which is extracted as the abstract, in the retrieved document on the basis of range setting conditions input by the input device; and
to extract a part suitable for the abstract, extracting one of the candidate ranges.

6. The method for creating a document abstract according to claim 5, wherein the range setting conditions include at least one of a limit condition which limits the document to be retrieved and a format condition for the candidate ranges.

7. The method for creating a document abstract according to claim 6, further comprising accepting input of the range setting conditions by an interactive input accepting device.

8. The method for creating a document abstract according to claim 5, further comprising accepting input of the range setting conditions by an interactive input accepting device.

9. A program for allowing a computer to realize:
a function for retrieving one of documents pre-stored in a database which meets the retrieval conditions, on the basis of input retrieval conditions;
a function for setting candidate ranges one of which is extracted as an abstract, in the retrieved document on the basis of input range setting conditions; and
a function for extracting one of the set candidate ranges which is suitable for an abstract of the document, on the basis of input abstract creation conditions.
